(19) United States
(12) Patent Application Publication
(10) Pub. No.: US 2014/0379441 A1
(43) Pub. Date: Dec. 25, 2014

(54) SYSTEM AND METHOD FOR INTEGRATED MOBILE PARKING PAYMENTS

(71) Applicant: CANADIAN PARKING SYSTEMS & TECHNOLOGY INC., TORONTO (CA)

(72) Inventors: Gerardo Alberto Cabrera Avendano, Toronto (CA); Maria Del Pilar Cabrera Avendano, Toronto (CA); Oscar Enrique Villegas Cubillos, Bogota (CO); Fabian Garcia Avilan, Bogota (CO); Frank Carlos Cure Perez, Puerto Colombia (CO)

(21) Appl. No.: 14/345,075

(22) PCT Filed: Sep. 17, 2012
(86) PCT No.: PCT/CA2012/000865

§ 371 Date: Mar. 14, 2014

Related U.S. Application Data
(60) Provisional application No. 61/535,665, filed on Sep. 16, 2011.

(51) Int. Cl. G07B 15/02; G06Q 20/32

(52) U.S. Cl. CPC G07B 15/02; G06Q 20/3255
USPC 705/13

(57) ABSTRACT

In one aspect of the present invention, a web and mobile network; implemented system is provided for enabling payment for parking, using a mobile device, and also for enabling the management and/or enforcement of parking. The system provides an integrated platform, including at least one server component that is operable to interoperate with two or more mobile devices associated with users registered to the server component, for enabling the registered users to pay for parking by operation of their mobile device. The server component is configured to enable registered users to pay for parking from a wide variety of mobile devices, for example, based on text messaging communications between a mobile device and the server component, or by operation of a mobile application loaded on a mobile device that is a smart phone for example. The web implemented system is linked through a wireless network to one or more parking meters or tower components.

### FIELD OF THE INVENTION

The present invention relates generally to parking systems enabling use of a mobile device for payment. The present invention relates more particularly to mobile networks and mobile applications for enabling use of a mobile device for managing parking of a vehicle, and payment for parking,

### BACKGROUND OF THE INVENTION

Public parking areas are usually administered by municipalities or private owners, or managers appointed by either of these. The costs associated with administration of parking areas are significant. These may include human resources (e.g. parking attendants or parking enforcement personnel). Prior art technologies for controlling access to parking spaces and for administering parking payments are relatively expensive to purchase, and to maintain. Parking systems are often the targets of theft and vandalism, especially in large cities. These problems are especially pronounced in parking areas outside of parking lots, for example, in public parking zones such as paid street parking spots. Public parking zones are usually administered by city administrators, and these are especially difficult and costly to manage. The revenues generated by municipalities are significant but because of significant costs, there is an opportunity for a more efficient system for administering public parking zones, including associated enforcement.

### SUMMARY OF THE INVENTION

In one aspect of the present invention, a web and mobile network implemented system is provided for enabling payment for parking, using a mobile device, and also for enabling the management and/or enforcement of parking. The system provides an integrated platform, including at least one server component that is operable to interoperate with two or more mobile devices associated with users registered to the server component, for enabling the registered users to pay for parking by operation of their mobile device. The server component is configured to enable registered users to pay for parking from a wide variety of mobile devices, for example, based on text messaging communications between a mobile device and the server component, or by operation of a mobile application loaded on a mobile device that is a smart phone for example. The web implemented system is linked through a wireless network to one or more parking meters or tower components. Significantly, the parking meters of the present invention are configured, and integrated with the server component, to enable users to initiate one or more wireless communications with the server component to initiate payment for parking, for example, even if the user is not registered with the system and/or the user or registered user is not in possession of a mobile device at the time s/he wishes to park or pay for parking.

The integration of the server component, that is web and mobile network implemented, with mobile devices by operation of the mobile messaging functionality integrated in the server component, or by operation of the mobile application described herein, and also with the parking meters or tower components, as described herein, provides the integrated parking payment system architecture of the invention. This integrated parking payment architecture is novel and highly innovative, and provides significant flexibility in enabling users to utilize mobile payment technology through a number of different workflows (detailed below) that enable operators of the present invention to enable virtually an entire population to engage in mobile parking payment. This aspect of the invention is critical to user adoption, which in turn provides significant advantages to operators.

More particularly, the present computer system combines: (A) accessibility of text messaging based interactions with a server component to enable mobile parking payments, (B) the availability of meters linked to the server component to enable parking payment processing if users are not yet registered to the system, or do not have a mobile phone or do not have their mobile phone with them. The computer system of the present invention is cost effective and also addresses substantially all of the parking public, with few barriers to adoption,

Another advantage of the system of the present invention is that a single computer system may be used for administering public parking zones and also parking lots. This enables for example municipalities to take advantage of critical mass, and associated reductions in cost and greater efficiency.

The system of the present invention is designed to be cost effective. Prior art solutions generally include parking meters that are hardware and software intensive, and costly to manufacture and to maintain.

In one aspect of the invention, a mobile network implemented parking payment computer system is provided, comprising: (A) one or more server computers, connected to a computer network, and also connected to one or more mobile networks by means of a wireless gateway; (B) a server application linked to the one or more server computers, the server application providing: (1) a parking payment utility that enables two or more users using their mobile device(s) to initiate one or more operations for: identifying a parking spot occupied or to be occupied by a particular user; and initiation of payment for parking by operation of a payment component of the server application; and (2) at least one parking meter configured to communicate with the server application, and enabling the two or more users to initiate payment for parking even if a particular user is not registered to the server application, or even if a particular user is not in possession of their mobile device(s) at the time of parking; wherein the one or more web servers and the at least one parking meter provide en integrated solution for mobile parking payment.

In another aspect, the computer system is linked to one or more payment processing systems, and the parking payment utility enables the creation of one or more prepaid accounts.

In another aspect, the computer system further comprises a communication utility, wherein the communication utility includes text messaging functionality, and enables users to communicate with the server computer in order to engage in mobile parking transactions using text messaging.

In a still other aspect, the user utilizes text messaging using either his/her mobile device or the parking meter, in order to engage in mobile parking transactions with the server computer.

In another aspect, the parking meter is configured to support automated identification of parking spots occupied by a particular user.

In yet another aspect, the computer system is configured to that: (A) a user sends to the server computer user credentials, parking spot location information, and an “activate parking” request to the server computer; (B) the server computer receives the information in (a) and accesses parking payment parameters associated with the parking spot location, and optionally also the user; (C) the server computer accesses a profile for the user, and obtains information regarding the current prepaid account for the user; or (D) if the current prepaid account meets one or more threshold parameters, the server computer debits the prepaid account based on the time elapsed between the “activate parking” request, and a “terminate parking request”.

In another aspect, the server computer sends one or more communications, based on one or more established communication parameters, to remind the user regarding one or more of: (A) the current prepaid account amount for the user; (R) parking time elapsed and optionally associated parking charges based on a current mobile parking payment session; (C) warnings that paid parking has elapsed, and optionally warnings as to parking fines, based on a current mobile parking payment session; (D) time available based on the applicable parking payment parameters before the prepaid account is depleted; (E) reminders to replenish the prepaid account amount; or (F) authorization to replenish the prepaid account based on a specified amount.

In another aspect, the computer system is operable to detect when a user has arrived in a particular parking location and automatically initiate a mobile parking payment session, and detect when a user has departed from the particular parking locations and automatically terminate the mobile parking payment session.

In a still other aspect, the computer system includes an enforcement module that provides one or more tools for use by parking enforcers to obtain: (A) information regarding vehicles parked in an area that are the subject of mobile parking payment sessions; and (B) information regarding vehicles parked in an area in an unauthorized manner.

In one aspect of the invention, a computer implemented method for enabling mobile parking payments, comprising: (A) a user providing to a mobile device user credentials, parking spot location information, and an “activate parking” request, and initiating this information to be sent by his/her mobile device to a server computer; (B) the server computer receiving the information in (a) and accessing parking payment parameters associated with the parking spot location, and optionally also the user; (C) the server computer accessing a profile for the user, and obtaining information regarding the current prepaid account for the user; and (D) if the current prepaid account meets one or more threshold parameters, the server computer authorizing the user to park at the parking spot location, and debiting e prepaid account based on the time elapsed between the “activate parking” request, and a “terminate parking request”.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DESCRIPTION OF THE DRAWINGS

FIG. 1 depicts an exemplary system diagram of a mobile parking payment and enforcement system, in accordance with one embodiment of the present invention.

FIG. 2 depicts a perspective view of a representative embodiment of the tower component of the present invention.

FIG. 2b depicts a circuit diagram illustrating one present invention

FIGS. 3a to 3e depict representative screen shots presented by the mobile application of the present invention.

FIGS. 4a to 4d show representative screen shots of administrative interfaces of the web application of the present invention.

FIG. 5 illustrates a possible generic computer system implementation of the present invention.

### DETAILED DESCRIPTION OF PREFERRED EMBODIMENTS

In one aspect of the present invention, a web implemented computer system is provided for enabling payment for parking, using a mobile device, and also for enabling the management and/or enforcement of parking. The computer system provides a comprehensive and integrated solution that includes one or more meters as described below. Also, the computer system is configured to operate using a prepaid account, with significant advantages described below.

The computer system provides an integrated platform, including at least one server component that is operable to interoperate with two or more mobile devices associated with users registered to the server component, for enabling the registered users to pay for parking by operation of their mobile device. The server component is configured to enable registered users to pay for parking from a wide variety of mobile devices, for example, based on text messaging communications between a mobile device and the server component, or by operation of a mobile application loaded on a mobile device that is a smart phone for example.

The Internet and mobile network implemented computer system of the present invention is linked through a wireless network to one or more parking meters or tower components.

Significantly, the parking meters of the present invention are configured, and integrated with the server component, to enable users to initiate one or more wireless communications with the server component to initiate payment for parking, for example, if the user is not yet registered with the system and/or the user or registered user is not in possession of a mobile device, at the time s/he is parking.

In addition, the system and its operation, as further explained below, is configured to enable communication with a wide variety of mobile devices, using a variety of communication protocols. Significantly, the present invention is configured to enable the operations described below using text messaging or Short Message Service (SMS) text message or in a similar data transmission protocol.

Further details regarding the operation of the system are provided below.

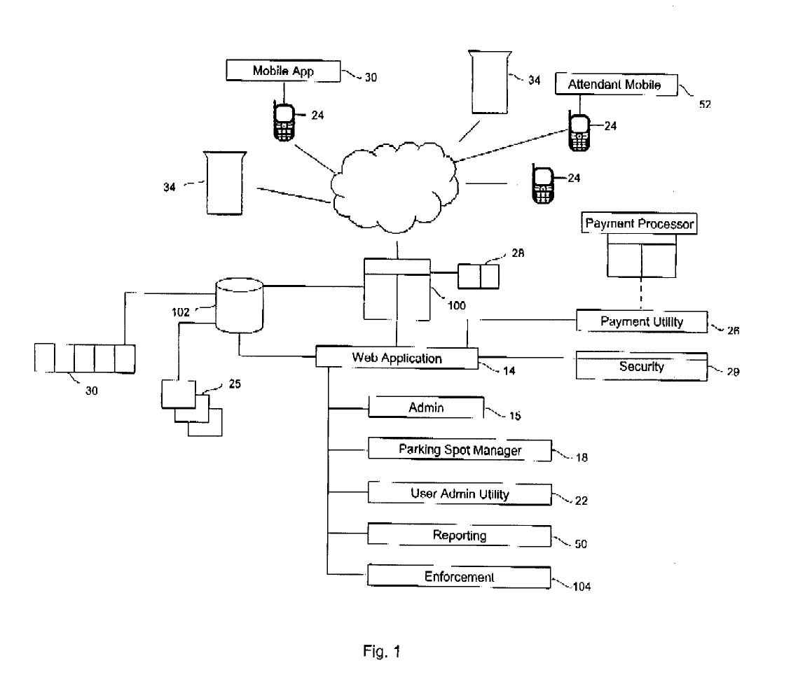

The system of the invention may be implemented using a number of different collections of hardware and software elements. FIG. 1, however, illustrates a representative implementation of the system. As shown in FIG. 1, the system may include a web server (100). However, it should be understood that the web server (100) may be implemented as an associated plurality of servers or server farm, or using a cloud network. The web server (100) may be linked to a database (102). The web server (100) includes a web application (14) in accordance with the present invention. The web application (14) includes one or more software components, or embodies one or more software routines, for enabling the server side operations describe in this disclosure.

The web application (14) may define an administrative area or administrative utility (15) that may enable administrative users of clients of the operator of the web server (100) to access one or more administrative functions, or one or more administrative functions dedicated to particular clients or operators. For example, the web application (14) is configured to enable a number of possible workflows for payment for parking and enforcement. For example, the system of the present invention permits a range of possible mechanisms for users to pay for parking in a particular parking spot. In some implementations of the invention it is necessary to provide information regarding a particular parking spot where the user is parking, and in others for example only parking zone information is required and this may be obtained by the system automatically, as explained below. The administrative utility (15) enables administrative users of the operator to assemble the elements of the workflow for various types of users (e.g. users parking their vehicle or parking enforcement personnel) based on the various parking/enforcement features enabled by the present invention. The administrative utility (15) presents a range of menus enabling the selection of workflow elements including for example supported types of devices, content of information required from parking users, format and content of messages sent back to parking users, and so on.

The administrative utility (15) may be configured to include a range of different templates based on a collection of possible operator preferences, which an administrative user may then customize for a particular operator, using one or more menus, in a manner that is known. It should be understood that the system is configured to be relatively flexible, and therefore enable the system to be configured to respond to the variation in parking/enforcement related requirement from municipality to municipality, or from parking lot owner to parking lot owner, or parking authority to parking authority, for example. It should be understood that the present invention enables the integration of various different operators, through the platform of the present invention, thus permitting significant economies of scale and also a consistent user experience for individuals.

The server may be linked to a database (102) for storing data, including client data. Client data may include data related to management of parking operations of the client, including for example transactional data. The database (102) may be implemented using database technologies that ensure that client data is restricted to only users authorized by the client.

It should be understood that various functions of the web application (14) made available to clients may be organized into a client dashboard, in a manner that is known. A client dashboard may provide access to a variety of different features and functions that enable a client (such as parking authority) to set parking rates, zones, parameters of reminders, administration of prepaid user accounts and so on.

The web application (14) includes or is linked to a utility that is operable to log a plurality of parking spots associated with the server, which may be understood as a parking spot manager (18). In one implementation of the invention, a unique identifier may be provided for each parking spot under management by operation of the server. The parking spot manager (18) may include or link to a range of tools for managing parking spots. For example, in one implementation of the present invention, the parking spot manager (18) may include or be operable to access map data and may enable users to navigate to specific map areas to enable access to a variety of maps (and modify parameters such as map resolution) for viewing parking spots and associated data such as parking spot identifiers, and also managing (creating, assigning, generating, updating etc.) associated data such as pricing information, statistics for specific parking spots and the like. It should be understood that the parking spot manager (18) may include or be linked to one or more map data or map data management tools and technologies, whether known or to be invented. A skilled reader will understand that map data functionality, and associated data management tools, can enhance the information access and management features of the system of the present invention.

The parking spot manager (18), in one implementation, enables administrative users to create one or more profiles for parking spots, or more commonly for parking spot zones. One or more menus may be used as an input interface for entering information such as parking pricing, associated timing information, and optionally associated enforcement penalties.

Linked to the parking spot manager, the web application (14) optionally may include an enforcement utility (20). The functions of the enforcement utility (20) are further explained below.

The web application (14) also includes a user administration utility (22). The user administration utility (22) may be implemented as part of the administration utility (15). The user administration utility (22) enables users to register with the system of the present invention and create their profile on the database (102).

For example, users of the system may be required to provide their license plate number to the web server (100), and in response the system may provide a user number, which may be registered to the user's profile stored to the database (102). In one aspect of the present invention, the user administration utility (22) may require users to provide the following information to register with the system (A) their name, (B) address, (C) vehicle information (including license plate number, and optionally year, make and colour of vehicle), and (D) payment information. Payment information may include any means of payment such as a credit card number, direct account withdrawal information, electronic payment information such as PAYPAL™, payment by inclusion in other bills such as wireless carrier bills. It should be understood that preferably payment information includes merely credentials for enabling transactions to be processed by a third party such as a financial institution or merchant acquirer. In other words, the retention by the operator of the system of the present invention of data required for processing financial transactions may not be required. The present invention contemplates the use of a variety of third party technologies and processes for enabling secure transaction processing of payments related to creating or replenishing accounts (25). The accounts (25) may be established on the database (102) by operation of the web application (14).

The user administration utility (22) may also enable each user to define certain settings in regards to the operations of the system of the present invention. For example, in order to optimize operations and display of messages from the web server (100), the user administration utility (22) may enable the user to provide details regarding his/her mobile device (24) in order optimize the display of for example text messages initiated by the web server (100) as explained below.

In addition, the user may for example be able to provide payment settings by operation of the user administration utility (22). The user administration utility (22) is operable to define a running account (25) for each user, which may be established on database (102) and linked to the users profile, which account (25) may be debited by operation of the payment utility (26). The payment utility (26) is best understood as an interface for linking the system of the present invention to one or more payment systems for processing user payments to the applicable user account (25) using the requisite authentication data or technology, in a manner that is known. In this way, the payment utility (26) may consist of an API for a third party payment server (27), which is operable to link the operations of the platform of the present invention to the third party payment server (27) for the purposes of processing the financial transactions described herein.

The user administration utility (22) is also operable to debit user accounts (25) based on initiation of the electronic parking operations enabled b_{y} the system of the present invention, as described below.

The system may include a further authentication/security utility (29) which may include one or more utilities of restricting access to the resources linked to the web server (100), and also to prevent hacking of information stored to the database (102), maintaining the privacy of any personal information, or restricting access to information of one entity only to authorized users of that entity.

It should be understood that in one aspect of the invention, the system operates on the basis of prepaid block amounts. This minimizes the number of transactions with third party transaction companies such as merchant acquirers, and credit card payment companies. This can minimize transaction fees for users, and reduce processing load on the system. The pre-payment mechanism is favourable for the operator of the system and the operators client (parking operators, parking authorities, municipalities and the like), in providing strong cash flow without significant or any account receivable expenses.

The user administration utility (22) may enable each user to define one or more payment related settings. For example, a particular user may authorize the system to automatically debit specified accounts to replenish his/her running account (25), by a specific amount, for example upon the running account (25) diminishing to a specific level. Various other payment related settings are possible.

The web application (14) includes a communication utility (28). The communication utility (28) is best understood as a series of communication hardware and/or software components that enable the multi-platform and multi-device communications referenced in this disclosure. The communication utility (28) may be linked to the user administration utility (22) in order to process communications based on user preferences (whether the operator or the parking payor). The relevant communications generally fall into two categories: (A) communications with parking users, and also (B) communications with authorized users who are personnel of clients of the operator of the system. The first category (A) may be referred to as “parking user communications”, and the second (B) category may be referred to as “administrative messages”.

The parking user communications generally relate to the processing of parking operations as particularized below. The administrative messages are further explained below.

As referred to above, a user of the system may have in their possession a mobile device (24).

As is well known, not all individuals have mobile devices (24) that are smart phones, whereas it is important that the system address a significant proportion of addressable individuals who may be park in parking zones associated with the system. In one particular aspect of the invention, the system is configured to enable the processing of parking operations using text messaging, as explained below. This is advantageous in that not all parking users have a smart phone for running the mobile application of the present invention, whereas text messaging is becoming ubiquitous.

The communication utility (28) is in part configured to assemble parking user communication in the form of text messages, and also process text messages from registered users to initiate server operations as explained below.

As stated earlier, the parking spot manager (18) may associate a unique identifier or parking spot identifier (30) with each parking spot.

### Identifying the Parking Spot or the Parking Zone to the System

In one aspect of the invention, an identifier is determined for the particular parking spot where a user wishes to park or has parked and now wants to initiate payment for parking by operation of the system of the present invention. The identification of the particular parking spot has the advantage of the system identifying the particular spot where a vehicle has parked, which has implications for certain parking management operations mentioned below, such as tracking of available parking spots linked to the system, and for example in a particular geographic area, and also for enforcement of parking violations also as further explained below.

Alternatively, in another implementation of the present invention, identification of a parking zone rather than a parking spot is required. The parking zone identifier may be associated with particular parking payment information, for example differing charges and associated time of day information, and/or parking restrictions, which may be stored to the database (102) by operation of the parking spot manager (18). Identification of the parking zone by the user, rather than an identifier for a particular parking spot by the user, has the advantage of greater convenience to the user because the user does not need to verify the code associated with the parking spot, and may know the parking zone identifier for the area by memory for example.

The parking spot may be marked with the same identifier or other identifier mapped in the database (102) to the said parking spot identifier (30). The identifier may consist for example of an alphanumeric code that is painted on a curb or sidewalk, or marked on an article such as a brick that is integrated with the curb or sidewalk, marked on a wall in the vicinity of the parking spot, marked on a sign at eye level for a vehicle driver, or some other suitable mechanism,

Alternatively, a mobile device (24) may be initiated by a user to send a communication to the web server (100) to obtain the identifier for the particular parking spot that is currently occupied by a user. The web server (100) may be operable to initiate one or more processes linked for example to location based services supported by the mobile device (24) and/or the associated mobile application (30) so as to identify the approximate location of the mobile device (24) and based on this determine the probable particular parking spot occupied by the user.

It also should be understood that the meter (34) of the present invention, further described below, can also play a role in enabling the identification of the particular parking spot occupied by a particular user at a particular time. In one implementation of the invention, the meter (34) may include a parking spot locator (36), implemented using one or more hardware/software utilities, that enables the meter (34) to cooperate with a mobile device (24) of a user so as to enable the identification of the particular parking spot occupied by the user associated with the mobile device (24). In one example of implementation of this functionality, a user of a mobile device (24) initiates a communication to a local meter (34) to obtain this information. This communication may be routed through the web server (100) to one or more meters (34) in the general location of the mobile device (24), which may include information for the mobile device such as a cell number, email, PIN code or other information suitable for sending a communication to the mobile device (24). The meter (34) then initiates a communication with the mobile device (24) which communication may include a request for location information from the mobile device (24). The mobile device (24) may then send a communication to the meter (34) in reply, with one or more items of location information. This may consist of providing the identifier for the parking spot referred to earlier (e.g. marked on the curb at the parking spot in question). Additional information elements may also be provided, which the meter (34) (or the meter (34) relying on the web server (100)) may then use to calculate the particular parking spot likely to be occupied by the user, using one or more wireless localization techniques. For example, in installing the meters (34) a radio map may be established based on known technologies, and this radio map may be used by the one or more local meters (34) to communicate with the mobile device (24) and thereby extrapolate its then current location, place this location within a map established for parking spots associated with the meter, and look up from a library stored on the meter (34), or otherwise accessible by the meter (34) for example by engaging in a look up operation involving the database (102) based on a communication between the meter (34) and the web server (100).

A skilled reader will understand that the integration of meters (34) in accordance with the present invention may enable more precise and more cost effective parking spot identification using mobile location services than is possible using prior art solutions. GPS solutions for example may not be precise enough in high rise downtown settings.

It should be understood that numerous other mechanisms are possible for identifying the particular parking spot occupied by the user. As explained above, this information may be obtained automatically by operation of the system. It should also be understood that in certain municipalities standard parking charges may exist regardless of location, and that may vary only based on time, in which case the location of the parking spot may be less important.

### Meter Design

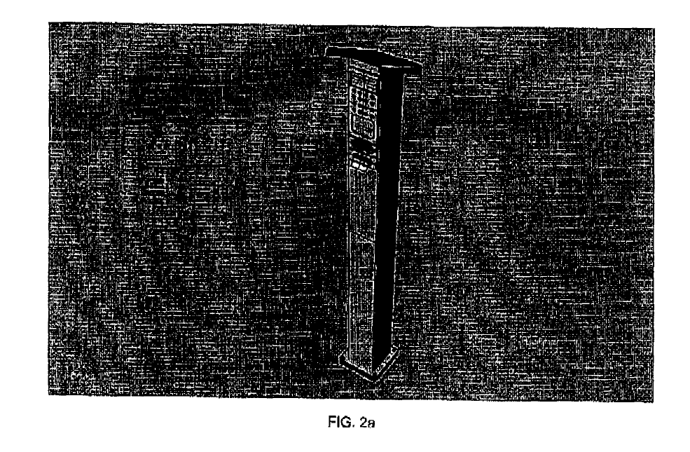

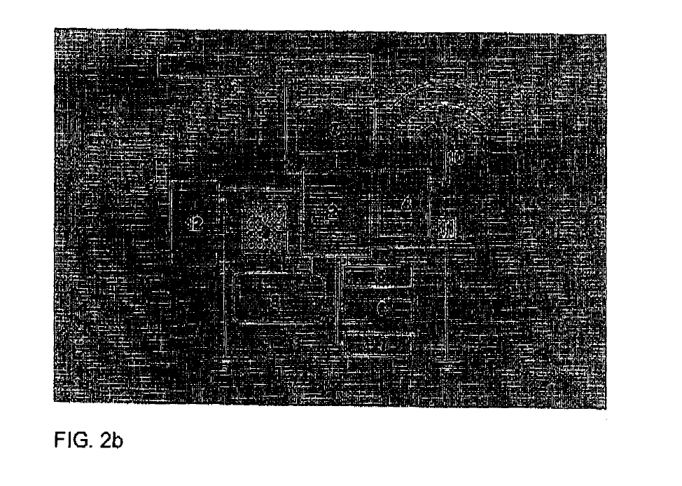

In one aspect of the invention, a representative embodiment of the parking meter (34) of the present invention is illustrated in FIG. 2a. The parking mater (34) includes a casing, and is generally formed to assume a post configuration. The material used in making the casing, and its manufacturing method is preferably selected to provide a structure that is relatively sturdy and invulnerable to tampering or vandalism. The meter (34) includes a wireless network connector (40) for establishing a communication link to one or more wireless networks associated with the operator of the system.

The parking meter (34) of the present invention may include hardware and software suitable for enabling users to pay for parking using payment cards. This may include a car reader suitable for reading financial information from credit cards or debit cards, or a contact-less smart card reader. The parking meter (34) may also include a screen device suitable for displaying pertinent information. The parking meter (34) is operable to connect to the server (100) in order to process transactions, or alternatively to an associated server of a third party payment processor. It should be understood that the parking meter (34) is also operable to enable a registered user to pay for parking by deducting one or more amounts from their account (25), thereby enabling the registered user to the use the parking meter (34), when s/he does not have a mobile device on their person. Alternatively, a user who is not yet registered to the system may use the parking meter (34) to park at parking spots associated with the system of the present invention.

It should be understood that the parking meters (34) of the present invention are operable to receive or obtain an identifier for the relevant parking spot, for example, by the user entering to a keyboard made part of the parking meter (34) information identifying the relevant parking spot. It should be understood that a single parking meter (34), based on the design of the present invention, and based on the architecture described, may serve a relatively large number of parking spots.

It should be understood that in prior art systems, the payment related infrastructure is located in the meter. This requires deployment in the local meter of the hardware and/or software infrastructure that is relatively costly to manufacture and maintain. The distributed architecture of the present invention, wherein the applications that enable the operation of the system are located on the server (100), provides significant cost saving in terms of the manufacture, deployment, and maintenance of electronic parking meters.

In one aspect of the invention, the system is configured to use an integrated communication protocol to enable seamless transfer of commands across the components of the system of the present invention.

As shown in FIG. 2a, the housing (42) includes or is connected to a solar panel (44). The solar panel (44) may be enabled to charge a suitable energy storage device.

FIG. 2b includes a possible implementation of the parking meter in accordance with the present invention. FIG. 2b illustrates more specifically possible electronic components of a particular implementation of the parking meter design of the present invention. The electronic components may include a microprocessor (2), and the wireless network connector (10), which may include an antenna modem (10) and one of more SIM cards for network connectivity. The parking meter may also include one or more cell communication modules (4) or modems for providing network connectivity via one or more accessible cellular networks, for example using SIM cards. The wireless network connector (40) is configured to enable the meter (34) to establish wireless communications with the Server (100) to enable essentially the operations referred to below as between a mobile device (24) and the server (100).

The parking meter may be powered using a battery (12) which may be for example a 6 volt battery system. A solar panel (1) may be attached to the parking meter casing, in order to power the parking meter.

It should be understood that the electronic components illustrated in FIG. 2b may be implemented to a suitable main board.

The central processing unit (2) or CPU may contain a programmable microprocessor that can be configured to process any operations required for example for card processing, and to enable the communications described herein. A display (3) may be linked to the CPU to display information to the user such as for example parking costs, available account balance for parking and so on. The parking meter (34) may incorporate for example a reader for contactless cards (5), contact card readers (6), or magnetic card readers (7). A set of brackets may be used to receive one or more host communication cards (SIM cards) to enable communications between the parking meter (34) and web server (100), utilizing the integrated modem described.

In one implementation, the display (3) may be configured to present a user interface and functions that are similar to those of the mobile application in order to provide a consistent user experience, and to provide integration of the meters (34) as an option for using the computer system of the present invention, for example if the user is not registered to the computer system or does not have their mobile device on them.

A skilled reader will also appreciate that the configuration of the computer system to enable the user of prepaid accounts as described provides improvements relative to the use of meters (34). Processing of transactions from meters (34) connected to a wireless network is generally relatively slow, or alternative relatively expensive hardware/software/networking infrastructure is required. This often produces lines of individuals trying to process transactions from meters. In contrast, the use of prepaid accounts has the further advantage of decreasing infrastructure requirements at meter, and furthermore decreases wait times. The initiation of a “START PARKING SESSION” communication to the server component is rapid and does not require significant infrastructure.

In one aspect of the invention, the meters (34) connected to the system require only text messaging capability, used in the same way as mobile device in accordance with the present invention.

Parking meter (34) may be configured to accommodate data cable to establish physical data connections where available.

The parking meter (34) may be operable to provide to the third party payment processor data communications including necessary information for processing transactions. This may be important, for example, if the user is not yet registered to the system of the present invention.

The parking meter (34) may be constructed of durable materials to avoid tampering with the components disposed inside the parking meter casing, and to enable anchoring of the parking meter (34) for example to a sidewalk.

The meter (34) may also include a printer (8) for tickets or paper receipts. For users that are not registered to the system, and therefore the system cannot track payment by the parking payor, it may be desirable to print a paper ticket which the parking payor may place inside their vehicle so that it is visible from the outside, as is generally the case using prior art parking payment meters. The printer may also be used to print paper receipts of payment, if this is desired by users, however, to reduce waste this option may be configured as an exception, and even a small extra charge may be associated with this request.

It is useful to provide an example of the use of the parking mater (34) of the present invention by a parking payor or user. The user approaches the communications post and engaged the appropriate card reader for example by entering his/her card into the magnetic strip reader slot (7). The reader obtains the necessary data elements and the CPU (2) directs the communication modem to establish a communication channel with the web server (100) and/or one or more servers associated with the third party payment processor(s). The CPU (2) may prompt the user to provide a user code (for example to register to the system if the user is registered and does not have his/her mobile device, or PIN code that may be required by the payment card provider, or to enter the parking payment amount). The CPU (2) may further direct the communication of this information to the one or more appropriate remote servers. Subject to authorization by the appropriate servers, the system of the present invention may authorize the parking by the user, and optionally this message may be displayed by means of the display (3), and further the web server (100) of the present invention then activates the parking of the user in the relevant parking spot based on the associated parking parameters for example parking for the maximum parking time.

When the user is leaving his/her parking spot, s/he may log into the system again, using the keyboard (9) for example to provide a username or password, for example, or some other authentication means may be used. The display (3) may present a button that displays “LEAVING PARKING SPOT” or equivalent to initiate the related operations using the parking meter (34). This initiates one or more communications with the web server (100) to deactivate the parking session of the user, in the particular parking spot, as logged by the web server (100). The display (3) may display a message such as YOUR DEPARTURE FROM PARKING SPOT HAS BEEN LOGGED″ or some equivalent. The web server (100) in the background, as described herein, applies the necessary debits or initiates and logs the associated transactions. Optionally the display (3) may display the remaining balance of user's account in the system of the present invention. Also optionally, the user may activate a button on the display (3) to initiate the printing of a receipt.

It should be understood that the distributed mobile data architecture, and distributed application architecture described herein, which includes as part of an integrated systems, one or more meters (34) based on the design described, enables the use of meters that are much lower in cost to manufacture and to maintain, then is possible based on prior art technologies. Parking meters (34) may be the object of vandalism, however, based on the fact that in accordance with the present invention, the meters (34) do not include expensive hardware, nor do they contain cash, the likelihood of vandalism is low. Also, the meters (34) are easier and more inexpensive to replace in the event that they are subjected to vandalism.

### Operational Workflows

One aspect of the operational workflow enabled by the present invention Is that parking payors may use a mobile device (24) to activate the server (100) to initiate payment for a parking spot associated with the system when the user arrives in the parking spot, and terminate payment for the parking spot when they leave, on a prepaid basis.

Certain aspects of the operational workflow are described in greater detail.

The method of the present invention is best understood as a series of methods encompassing methods of paying for parking by operation of the system, and also methods of enforcement of payment by administrators or their agents.

The user is ready to initiate the web server (100) to enable mobile payment a request for payment for parking in the relevant parking spot, by operation of the web server (100). This request is generally initiated by the user inputting to the mobile device (24) information required to send a request to the web server (100). A suitable input facility may be used such as a keyboard associated with the mobile device, or for example by accessing a speech-to-text utility associated with the mobile device (24).

The request to the web server (100) may trigger a series of steps related to payment for parking using a mobile device (24). These steps may include: (A) authenticating the user to the web server (100) (a variety of mechanisms may be used), (B) web server (100) logging the request from the mobile device (24) to initiate payment for parking from the user of the mobile device (24), and thereby tracking the user as being parked legitimately, (C) linking a commencement time with the request to initiate payment for parking, and (D) initiating one or more server operations and/or communications related to processing parking and/or enforcement operations based on the parameters established by the operator by configuration of the system (using the administrative utility (15)).

In one implementation, each user is provided a unique code that is used to authenticate to the system. The code may be for example a series of numbers that may be easily inserted into a text message for identifying the mobile device to the server component. Once a user has their unique code they may be permitted to park in designated areas associated with the computer system.

The computer system may also incorporate a series of easy to remember codes for structuring text messages for interacting with the server component. For example “*” may designate a command. “1” after a “*” may designate “ACTIVATE A PARKING SESSION” and “2” may designate “TERMINATE A PARKING SESSION”. Various other parameters are possible.

A skilled reader will also appreciate that the meter (34) may be deployed in locations where users may not have a wireless connection to their mobile device.

One or more mobile devices and one or more meters (34) may be managed and utilized by the server component, including on a dynamic basis, to obtain up to date information on occupancy of parking spots in a designated area, in an efficient way, and also in circumstances where wireless network coverage may not be optimal. The computer system provides improved parking place occupancy information for enforcement, and also for users to know if parking spots are available, and where they are available, so that they can locate an available parking spot more efficiently (whether in parking garages or for street parking). The computer system may link to other systems and platforms to provide location based services for locating parking spots.

In another implementation, sensors in certain environments may be linked to the computer system. For example, a sensor may be mounted adjacent to an entrance to a parking garage to automatically send an “ACTIVATE PARKING SESSION” message to the server component, and similarly a sensor may be mounted adjacent to an exit to a parking garage to automatically send a “TERMINATE PARKING SESSION” message to the server component.

It should be understood that the system enables a range of possibilities for (D). (E) upon receipt of the request to initiate payment for parking from the user, the web server (100) performs a lookup of the user's account to determine its balance, and calculates the amount of time based on the balance that the user can park (which may depend on the location of the parking spot) or DROP DEAD TIME. (F) If a request to terminate parking is received from the mobile device (24) before the DROP DEAD TIME, then (G) the web server (100) calculates the remaining balance in the user's account and sends a PARKING TERMINATION MESSAGE that confirms termination of the parking, and indicates the parking time start and end time and total cost of parking. The end of parking may be detected automatically upon the user leaving the general location of the parking spot paid for by operation of the system.

The PARKING TERMINATION MESSAGE may also include the remaining balance and a reminder to replenish the account and may include instructions for replenishing the balance.

In one aspect of the present invention, the communications between the mobile device (24) and the web server (100) may occur based on text messaging. For example, a registered user, may provide his/her identifier and optionally also his/her license number by means of SMS, or alternatively by inputting this information to a web page accessible via a mobile device (24).

The web server (100) by operation of the communication utility (28) may assign a code that identifies the parking payor. This may be provided to the registered user by any communication means, such as email notification, text message, or by mail. The code may consist of a short code or user name or client ID, which when combined with for example the user's license plate number is suitable both to identify the user and authenticate him/her to the web server (100).

This short code is used in the examples set out below, but other mechanisms for identifying the registered user to the web server (100) may be used.

(H) The web server (100) may be operable to manage a list of users authorized to park in zones or parking spots under management by operation of the server (100). This listed may be stored to the database (102) and updated dynamically based on further transactions described herein, i.e. communications indicating the arrival of specific users in specific parking spots, and their departure through parking termination messages as explained above. It should be understood that the list may be parsed into sub-lists so as to define lists of vehicles that are authorized to park in specific areas. Please see below regarding the use of such lists for enforcement, by operation of the present invention.

In another aspect of the present invention, the web server (100) is operable to track on an ongoing basis the balance of each user's account, for example by tracking each user who is logged in the system as being currently parked, and determining based on their balance and parking charges applicable for the relevant parking spot, when the account balance will be exhausted. In one aspect of the system, the communication utility (28) is operable to send one or more reminders to the user to replenish his/her account. The content and communication rules surrounding these reminders may be predetermined as system setting established by operation of the administration utility. For example, two hours before the exhaustion of account (25) based on currently accruing parking charges, the communication utility (28) may be operable to send a message, in a format preferred by the user, for example as an SMS stating “Your parking account will expire in 2 hours, and you will accrue automatic parking fines of $45.00 after that. Text *1129 to replenish your account.” Further instructions may be provided such as the characters to use to indicate replenishment by specific increments. Many variations of the messages and overall parking/parking enforcement settings are possible. The administrative utility (15) presents one or more web interfaces that enable an administrator to define and manage these settings.

It should be understood that from a user perspective, the present system provides significant convenience in enabling reminders to replenish accounts, reminders of purchased times about to expire, and easy to use mechanisms for avoiding parking fines. This will likely result in greater adherence to parking payment rules, resulting in additional revenue to operators. Some operators use extensive parking enforcement and indeed the resulting fines may sometimes exceed normal parking revenue, however, the enforcement costs associated assessing and collecting these fines is very significant indeed, and the enforcement outcomes can fluctuate and can be difficult to predict. It is for more desirable for operators to optimize revenue using the system of the present invention.

It should be understood that the server (100) may define a short period of time for enabling users to terminate their payment for parking, by operation of the meter (34), return to their vehicle and leave.

In one aspect of the invention, payment for parking as indicated above is operable to enable the updating of the authorized parking list, or authorized parking list for a specific area, as mentioned above, and also as further discussed below. Upon termination of parking, as discussed, the meter (34) initiates deduction of the money from the parking time (which may be linked to the preauthorization processes prior to provision of the ticket by the ticket printer and/or logging of the parking payor to the lists described.

It should be understood that the display of the meter (34) may be used to display additional screens and options that may enable the registration of the user to the system to enable use using their mobile device in future interactions.

In another possible implementation of the present invention, the computer system is configured to locate a nearby server component to process the transaction.

In another implementation of the present invention, system commands may be linked to short number combinations for ease of use using text messaging. For example, a three digit code may be assigned that means (“I AM PARKING IN ZONE X”). For example “*” may designate a command.

In another implementation of the present invention, the mobile application leverages connectivity with a vehicle to determine when the ignition of a vehicle has been turned on and this results in automatic termination of the parking session established with the server component.

In another possible implementation, mechanisms may be used to enable ACTIVATION or DEACTIVATION automatically. For example, sensors associate with entrances to a parking garage may initiate an ACTIVATION message, and with exists may initiate a DEACTIVATION message.

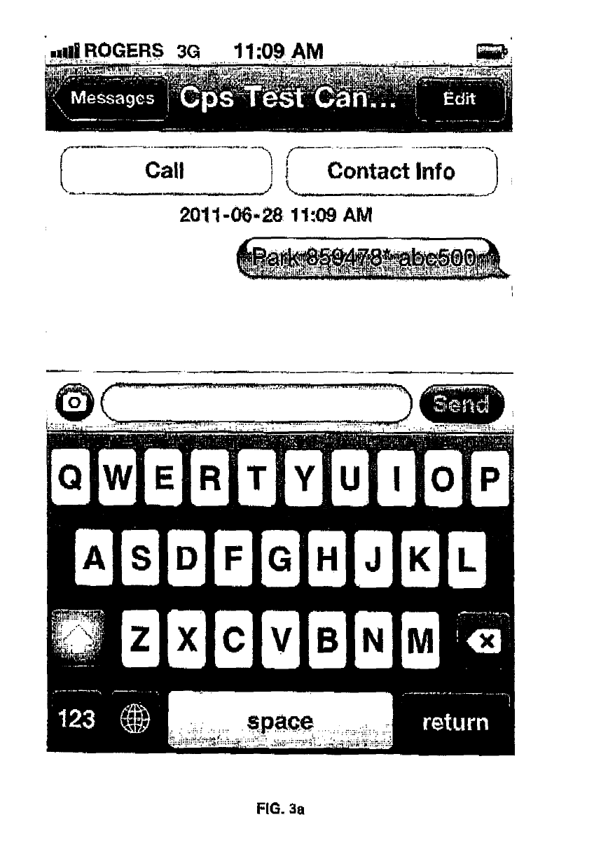

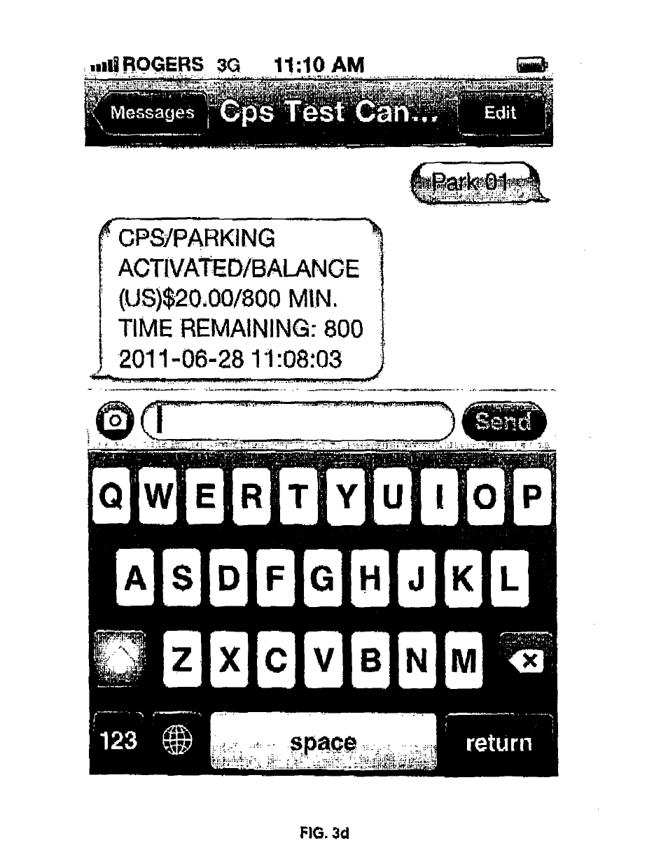

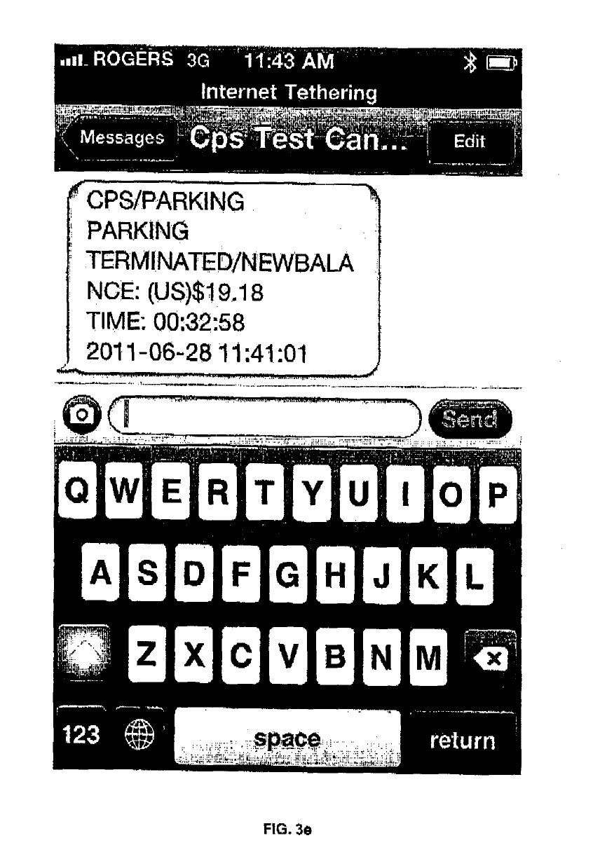

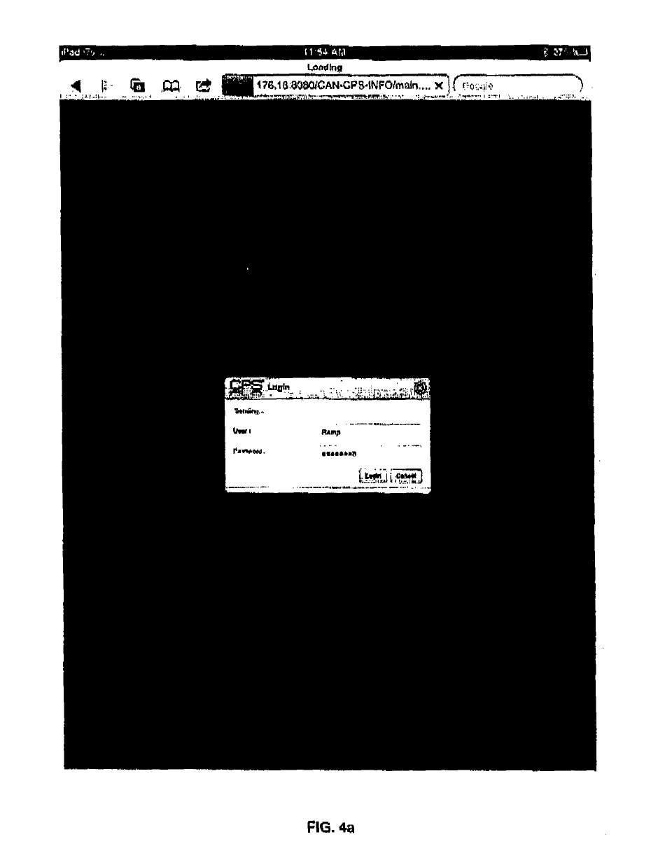

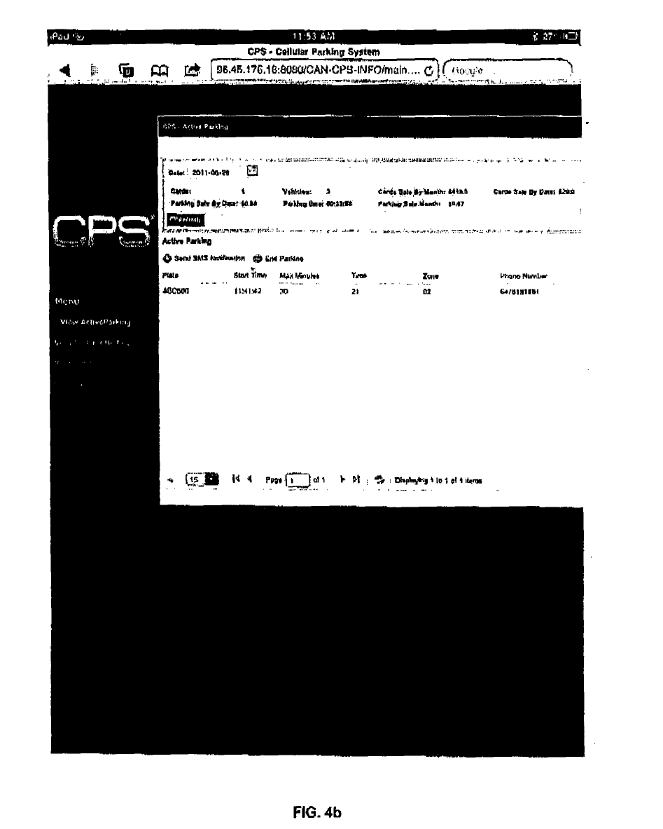

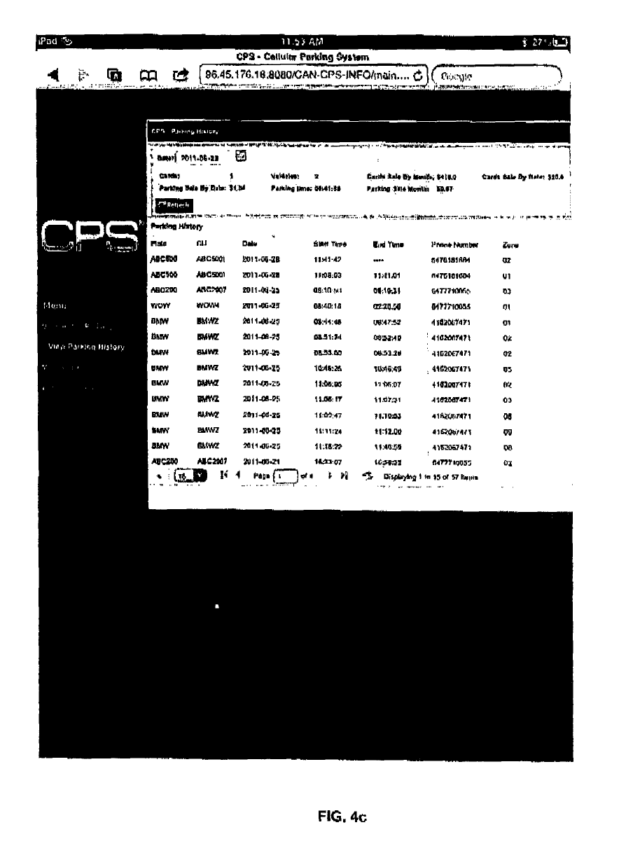

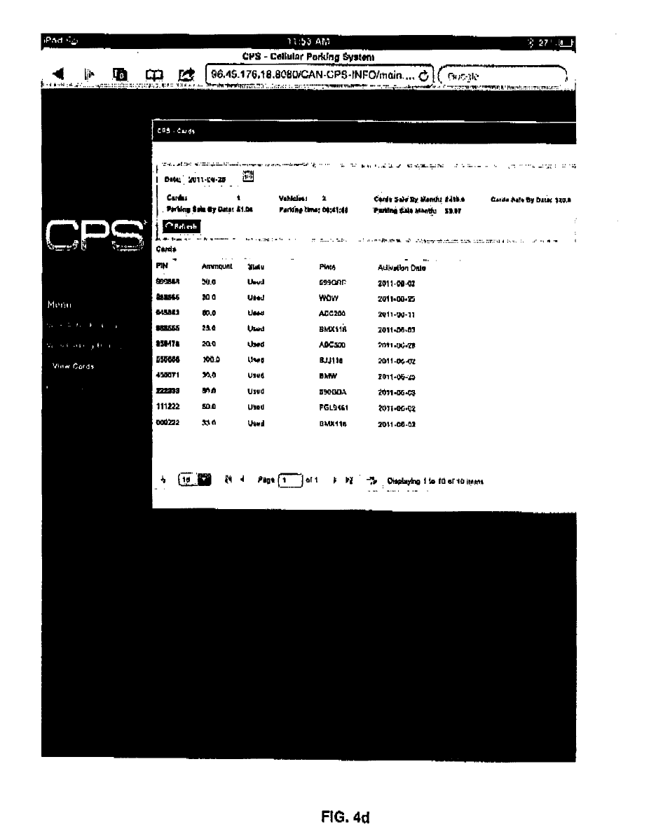

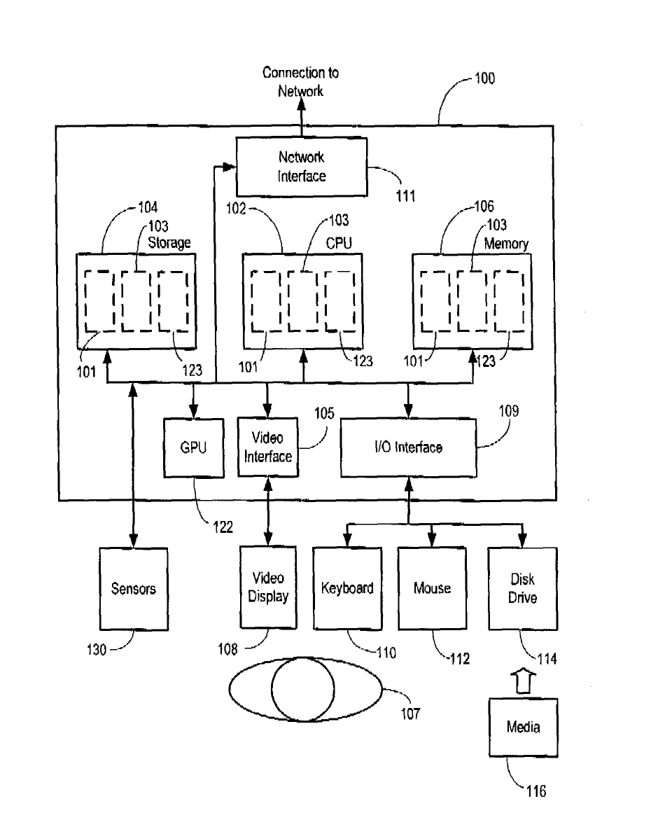

FIGS. 3a to 3e for example illustrates a series of mobile phone interfaces illustrating interactions between a mobile device (24) and the server (100) for initiating payment for parking using the mobile application, and based on the operations described herein.

### Mobile Application Features

This mobile device may include a mobile application (30) that is configured to interoperate with the web server (100) of the present invention. The mobile application (30) may be configured to locate and communicate with the web server (100) automatically. The mobile application (30) may be configured to obtain program updates dynamically from the web server (100) in order to access updates or upgrades to the mobile application (30), in a manner that is known. The mobile application (30) may be used for enabling the series of operations described above, but providing access to a richer interface. In addition, the mobile application may enable for example a dedicated inbox and outbox for managing communications related to operation of the system.

The mobile application (30) may also enable a user from a mobile device (24) to access a series of feature rich options, some of which are described below.

The mobile application (30) may automatically track, and optionally communicate with the web server (100) to verify, the then current balance of the user's account (25). The mobile application (30) may enable the user to define a series of settings such as alerts within specific time frames in the event the user's account has reached thresholds of depletion, or in the event that the user has parked the vehicle and is approaching for example times when parking is either prohibited or becomes more expensive.

The mobile application (30) may leverage locations based features of the mobile device (24) for example to generate (using GPS data) a map of the current vicinity of the user's vehicle, and based on a communication exchange with the web server (100), obtain a list of parked vehicles logged to the system of the present invention. The mobile application (30) may include, or be operable to access map data, indicating available parking spots. The mobile application (30) may also be operable to relate the map data of available spots with the list of parked vehicles so as to generate a modified map that may highlight using a suitable interface mechanism available spots in a defined area. It should be understood that illegally parked vehicles may not appear using this mechanism, in other words it is possible that in the case of an illegally parked vehicle, a spot will be erroneously be shown to be free. It should be understood that this aspect of the invention may be enhanced by using for example sensor arrays. Sensor arrays may be established for example by integration of sensor components in the meters, configured along with the placement of the meters to sense whether parking spots associated with the system are occupied or not. Alternatively, sensors may be integrated with the sidewalk or curb, as previously mentioned. It should be understood that various other technologies or methods may be used to enable the sensing of vehicles.

The mobile application (30) may also enable users to access one or more reports from the web server (100) for example accessing functions of the reporting utility (50) component of the web application (14). These may include history of user's account (25), outstanding fines, and so on.

### Administration/Enforcement

The system also sends real time information on each vehicle entering and leaving the zone to one or more supervising attendant (for example to their smart phone) allowing him to apply any corresponding fines to vehicles that violate the established rules or timeframes. As another example, a reporting utility (50) is made part of or linked to the web application (14) and database (102) in order to enable generation of a series of reports, in a variety of formats that may be used by attendants to enforce parking rules. These reports may include summaries of transactions related to vehicles entering and leaving a parking zone assigned to a particular attendant.

For example, attendants may be provided with an attendant mobile application (52) to obtain for example parking zone specific parking map data, essentially as described above in relation to the map functions of user mobile application (30). For example, the maps presented by attendant mobile application (52) may be operable to highlight in the presented interface vehicles that appear to be illegally parked, assuming for example the integration of technology for sensing when vehicles are occupying a particular parking spot. Alternatively, the maps presented by the attendant mobile application (52) may be operable to highlight vehicles that are parked in an authorized manner, indicating parking spot codes as well. During patrolling of a parking zone by an attendant s/he may use this map data to quickly identify spots that according to the system ought to be empty, and are not, indicating a vehicle that likely has parked illegally.

In one embodiment of the present invention, the attendant mobile application implements one or more enforcement related processes, which may be implemented as an enforcement module (104) of the attendant mobile application. It should be understood that the enforcement module (104) may also be implemented as a client application associated with a tablet computer for example, or device that is also operable to print parking tickets.

The attendant mobile application (52) is also operable to access data from the web server (100) regarding vehicles that are parked in an authorized manner, such as license plates of legally parked vehicles in the area. This enables the attendant to verify whether that a vehicle that appears, based on the operation of the system, to be illegally parked isn't in fact regally parked, but perhaps was moved to another spot, or the parking spot identifier was entered incorrectly. The architecture and configuration of the present system enables a series of mechanisms for attendants to verify parking infractions, and log to the web server (100) these verifications, in a manner that is linked to the profile of the user.

The administration utility (15) in part enables the operator or parking authority to establish the rules and preferences associated with the issuance of parking tickets, including for example the verification steps (if any) required by a parking attendant. It should be understood, that in one particular embodiment of the invention, it is the parking payor's responsibility to ensure that information is correctly entered, and that the vehicle is parked in the spot that was authorized for the payor by operation of the present invention. This enables automatic allocation of parking fines by operation of the system, which may also be paid based on operation of the platform, access to financial data, and the terms and conditions in place between the operator of the web server (100) and the user.

It should be understood that the enforcement module of the present invention may be integrated with a device that enables the printing of parking tickets, or alternatively, tickets may be issued by operation of the system electronically, or by accessing the relevant information including mailing address or other communication information associated with the license plate and sending the parking ticket automatically.

In one particular aspect of the present invention, the attendant mobile application (52) of the present invention is operable to indicate the location of vehicles where their parking is about to expire, for example because their account has not replenished, including the time between current time and the time of such expiry. This enables the enforcement officers to plan their patrols efficiently, to issue tickets and/or verify infraction related information, or collect additional information such as the taking of photos using their mobile device, which the attendant mobile application (52) may upload automatically to the web server (100), and associated with the profile for the relevant user, stored to the database (102). This information may be used in the event that a parking infraction is challenged by a user. In addition, the web server (100) may implement rules for applying a parking infraction automatically, and also rules for determining alternatively when further verification may be required. The maps presented by the attendant mobile application (52) may also indicate locations of vehicles where such verification is believed to be required.

It should be understood that the mechanisms described above significantly reduce the costs of enforcement, which normally take up a large proportion of the parking revenue.

It should be understood that the present invention may be extended by linking the invention with other technologies or processes useful in the monitoring the location of objects such as vehicles within predetermined area, and also their entry or departure from such predetermined areas.

### General

It will be appreciated that any module or component exemplified herein that executes instructions may include or otherwise have access to computer readable media such as storage media, computer storage media, or data storage devices (removable and/or non-removable) such as, for example, magnetic disks, optical disks, tape, and other forms of computer readable media. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD), blue-ray disks, or other optical storage, magnetic cassettes, magnetic tape, magnetic disk storage or other magnetic storage devices, or any other medium which can be used to store the desired information and which can be accessed by an application, module, or both. Any such computer storage media may be part of the mobile device, tracking module, object tracking application, etc., or accessible or connectable thereto. Any application or module herein described may be implemented using computer readable/executable instructions that may be stored or otherwise held by such computer readable media. FIG. 5 illustrates a possible generic computer system for implementing the described invention.

It will also be appreciated that the block configurations, screen shots, and flow charts provided herein are for illustrative purposes only and various modifications thereof are applicable within the principles discussed herein.

Although the above principles have been described with reference to certain specific embodiments, various modifications thereof will be apparent to those skilled in the art without departing from the scope of the invention and the claims appended hereto. Other modifications are therefore possible.

1. A mobile network implemented parking payment computer system is provided, characterized in that the computer system comprises:
(a) one or more server computers, connected to a computer network, and also connected to one or more mobile networks by means of a wireless gateway;
(b) a server application linked to the one or more server computers, the server application providing:
(i) a parking payment utility that enables two or more users using their mobile device(s) to initiate one or more operations for:
(A) identifying a parking spot occupied or to be occupied by a particular user; and
(B) initiation of payment for parking by operation of a payment component of the server application; and
(c) at least one parking meter configured to communicate with the server application, and enabling the two or more users to initiate payment for parking even if a particular user is not registered to the server application, or even if a particular user is not in possession of their mobile device(s) at the time of parking;
wherein the one or more web servers and the at least one parking meter provide an integrated solution for mobile parking payment.

2. The computer system of claim 1, wherein computer system is linked to one or more payment processing systems, and the parking payment utility enables the creation of one or more prepaid accounts.

3. The computer system of claim 1, wherein the computer system further comprises a communication utility, wherein the communication utility includes text messaging functionality, and enables users to communicate with the server computer in order to engage in mobile parking transactions using text messaging.

4. The computer system of claim 3, wherein the user utilizes text messaging using either his/her mobile device or the parking meter, in order to engage in mobile parking transactions with the server computer.

5. The computer system of claim 1, wherein the parking meter is configured to support automated identification of parking spots occupied by a particular user.

6. The computer system of claim 1, wherein:
(a) a user sends to the server computer user credentials, parking spot location information, and an “activate parking” request to the server computer;
(b) the server computer receives the information in (a) and accesses parking payment parameters associated with the parking spot location, and optionally also the user;
(c) the server computer accesses a profile for the user, and obtains information regarding the current prepaid account for the user; or
(d) if the current prepaid account meets one or more threshold parameters, the server computer debits the prepaid account based on the time elapsed between the “activate parking” request, and a “terminate parking request”.

7. The computer system of claim 6, wherein the server computer sends one or more communications, based on one or more established communication parameters, to remind the user regarding one or more of:
(a) the current prepaid account amount for the user;
(b) parking time elapsed and optionally associated parking charges based on a current mobile parking payment session;
(c) warnings that paid parking has elapsed, and optionally warnings as to parking fines, based on a current mobile parking payment session;
(d) time available based on the applicable parking payment parameters before the prepaid account is depleted;
(e) reminders to replenish the prepaid account amount; or
(f) authorization to replenish the prepaid account based on a specified amount.

8. The computer system of claim 1, wherein the server application provides an administration utility that enables users to set various parameters including payment card information, payment preferences, and system notification preferences.

9. The computer system of claim 1, wherein the computer system is operable to detect when a user has arrived in a particular parking location and automatically initiate a mobile parking payment session, and detect when a user has departed from the particular parking locations and automatically terminate the mobile parking payment session.

10. The computer system of claim 1, wherein the server application includes an enforcement module that provides one or more tools for use by parking enforcers to obtain:
(a) information regarding vehicles parked in an area that are the subject of mobile parking payment sessions; and
(b) information regarding vehicles parked in an area in an unauthorized manner.

11. A computer implemented method for enabling mobile parking payments, characterized in that the method comprises:
(a) a user providing to a mobile device user credentials, parking spot location information, and an “activate parking” request, and initiating this information to be sent by his/her mobile device to a server computer;
(b) the server computer receiving the information in (a) and accessing parking payment parameters associated with the parking spot location, and optionally also the user;
(c) the server computer accessing a profile for the user, and obtaining information regarding the current prepaid account for the user; and
(d) if the current prepaid account meets one or more threshold parameters, the server computer authorizing the user to park at the parking spot location, and debiting e prepaid account based on the time elapsed between the “activate parking” request, and a “terminate parking request”.

12. The method of claim 11, wherein the communications between the mobile device and the server computer are text messages.

13. The method of claim 11, comprising the further step of the server computer sending one or more communications to the mobile device, based on one or more established communication parameters, to remind the user regarding one or more of:
(a) the current prepaid account amount for the user;
(b) parking time elapsed and optionally associated parking charges based on a current mobile parking payment session;
(c) warnings that paid parking has elapsed, and optionally warnings as to parking fines, based on a current mobile parking payment session;
(d) time available based on the applicable parking payment parameters before the prepaid account is depleted;
(e) reminders to replenish the prepaid account amount; or
(f) authorization to replenish the prepaid account based on a specified amount,
